(19) United States
(12) Patent Application Publication
(10) Pub. No.: US 2014/0044576 A1
(43) Pub. Date: Feb. 13, 2014

(54) Golf cart accessory fan

(71) Applicants: Richard C. Geisland, Palm City, FL (US); Kimberly T. Geisland, Palm City, FL (US)

(72) Inventors: Richard C. Geisland, Palm City, FL (US); Kimberly T. Geisland, Palm City, FL (US)

(21) Appl. No.: 13/963,554

(22) Filed: Aug. 9, 2013

Related U.S. Application Data
(60) Provisional application No. 61/681,202, filed on Aug. 9, 2012.

(51) Int. Cl. B60H 1/24; F04D 25/06

(52) U.S. Cl. CPC B60H 1/244; F04D 25/06
USPC 417/423.5

(57) ABSTRACT

Disclosed is a self contained portable fan assembly for use with golf carts strategically positioned directly behind the seating area of a conventional golf cart. The portable fan assembly may include rechargeable batteries that can be charged within the assembly from an AC source or recharge directly from the golf cart batteries. The portable housing is constructed and arranged to span the stanchions of a conventional golf cart roof support employing an upper area of the seating area to provide housing support. Flexible straps permit ease of installation and removal.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 61/681,202, entitled “GOLF CART ACCESSORY FAN”, filed Aug. 9, 2012. The contents of which the above referenced application is incorporated herein by reference.

### FIELD OF THE INVENTION

This invention is related to the golf industry and, in particular, to an accessory fan positionable on a golf cart for cooling of the occupants.

### BACKGROUND OF THE INVENTION

The game of golf is a most enjoyable sport played by millions of golf enthusiasts. Golf is played on a course having separate tee/fairway/green combinations with the course averaging between 5,500 yards to over 7,000 yards, not including the distance between a green and the following tee. Golf is a sport in which the golfer advances a golf ball from a tee to a green in as few of strokes as possible. One of the most interesting aspects of the game is that every course has its own unique architecture with each golf course designer attempting to outdo other designers.

Golf is a sport that can be played anywhere that outdoor conditions allow. Golfing in the northern section of South America, Central America, and the lower section of North America is year round. However, golfing in those areas presents unique problems associated with heat. For instance, parts of Arizona can reach temperatures of over 110 degrees Fahrenheit wherein overheated golf enthusiasts can place themselves in a dangerous situation should they be subjected to a heat stroke. Southern Florida, parts of Mexico, Panama, Costa Rica and the like tropical areas have conditions where heat can combine with humidity to create an intolerable condition. In such areas a golf course can lose revenue when a round of golf is cancelled as the golfer seeks an endeavor that is more pleasurable. In addition, tropical areas including southern Florida, mosquitoes, no see-ums, flies and the like insect populations can affect a round of golf leading to cancellations. Even the upper section of North America including Canada face similar heat and bug problems during certain months of the year.

With the variance of golf courses and environments, most golf enthusiasts are not capable of walking an 18 hole golf course and carry the required golf clubs used in the sport. In this regard, the adaptation of an electric vehicle in the form of a golf cart has become widely accepted. The golf cart is specifically designed for use on a golf course allowing the occupants to move effortlessly between golf shots together with their golf clubs. The golf cart advances the speed of play as the golfers can move quickly from location to location and opens up the sport to numerous golf enthusiasts who would otherwise have difficulty in walking the course due to its length, conditions, or even temperature.

The introduction of the golf cart has made the game of golf more enjoyable as the cart includes a top for sunshade and basic conveniences. Unfortunately, the previously mentioned environmental conditions still exist and the temperature that the golf cart occupants are subjected to can remain intolerable and, in some conditions, dangerous.

One method of cooling the occupant of a golf cart is the placement of a fan within the cart. It is known in the art to attach a fan to one of the roof support stanchions, only along the inner surface of the roof so as to provide cooling conditions to the occupants.

The use of fans in connection with golf carts is known. U.S. Pat. No. 6,935,944 discloses a fan system for directing a flow of air at the occupants of the golf cart. The fan is powered by the use of a portable power pack, which consumer must carry in addition to the fan. The consumer must accommodate multiple wires to deal with, as well as a fan structure attachment, to effect operation. Additionally the clamping mechanism of the fan is prone to sliding down the roof support stanchion so that the flow of air no longer is directed at the occupant of the golf cart. Other known cooling devices include U.S. Pat. Nos. 5,547,343; 4,850,804; 4,799,850; 6,435,292; 6,325,362; 6,202,394; 6,158,140; 5,613,371; 4,899,931; and 5,112,535.

Thus, what is needed in the art is a fan system that is strategically positioned behind the occupants so as to cause the movement of air across the upper back, neck, and head of the individual effectively lowering the temperature of the individual by use of a self contained and rechargeable battery pack. The fan system creates a current flow of air keeping mosquitoes, no see-ums or the like pesky insects away from the golf cart occupants. The system is portable and can be installed for only a short time, but while installed it is stable and secure in the golf cart.

### SUMMARY OF THE INVENTION

Disclosed is an improved fan system for use with golf carts. The fan system consists of a housing constructed and arranged to span the distance between the roof support stanchions on a conventional golf cart. The fan system consists of two fans placed in a side by side position so as to cause direct air movement to the upper back, neck and head of the individuals seating in the golf cart, the fans positioned close to the individual allowing the use of smaller fans thereby lessening the need for a large battery pack. The fan system includes a self contained battery pack which is rechargeable by plugging into an AC adapter. The self contained batteries allow fan operation without degrading the length of the golf cart's main batteries that most prior art fan systems rely upon. In an alternative embodiment the fan system is portable and can be easily installed and removed to address those situations where fans are not necessary, such as in cool weather conditions. Alternatively the fan can be powered directly by the golf cart batteries when the fan system is installed in a more permanent situation.

An objective of the invention is to provide a self contained fan system for use with golf carts that can be strategically positioned directly behind the occupants of the golf cart to reduce fan size and accompanying energy consumption.

Another objective of the invention is to provide a self contained fan system having rechargeable batteries to eliminate drawing upon the main batteries of the golf cart.

Another objective of the invention is to provide a fan system that can be connected directly to the golf cart batteries for use in a more permanent situation.

Yet another objective of the invention is to provide a switching mechanism that allows for the combined or individual operation of fans.

Still another objective of the invention is to provide fan operation than can be controlled by the use of pressure sensors mounted to the seat or back rest of a golf cart seat allowing operation only when the seat is occupied.

Another objective of the invention is to provide a housing structure having angle brackets that allow for permanent attachment to the golf cart.

Another objective of the invention is to provide a housing structure having the use of hook and loop adjustment straps that allow transfer of the fan assembly between golf carts without damaging, modifying, or otherwise altering the golf cart.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a pictorial view of a golf cart with the fan assembly of the instant invention;

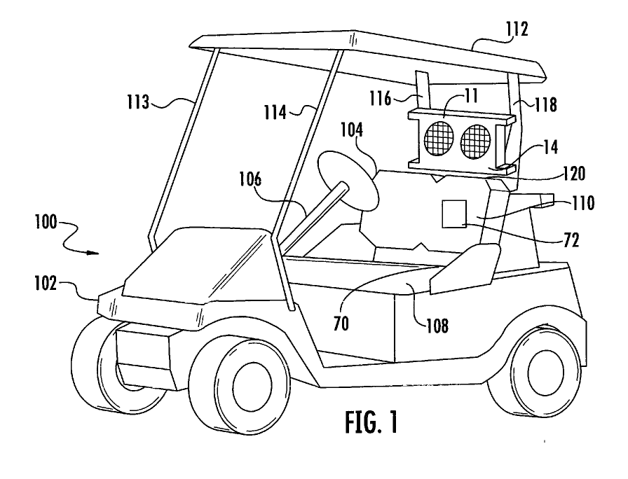

FIG. 2 is a front plane view of the fan assembly; and

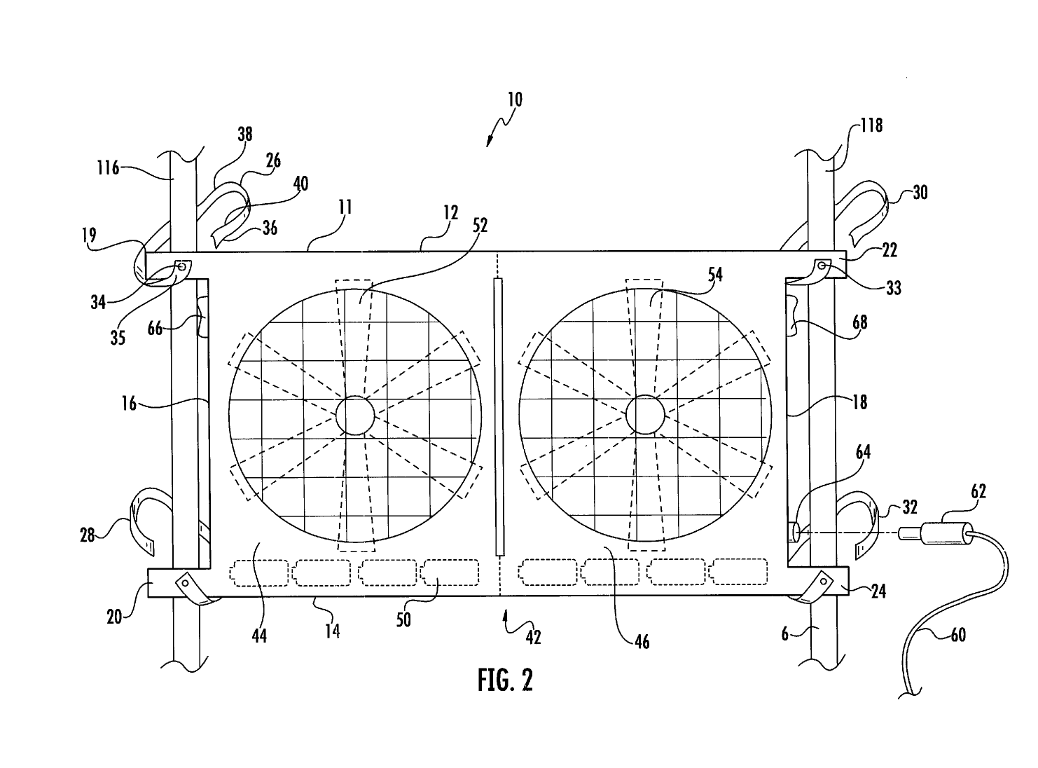

FIG. 3 is a top cross sectional view of the fan assembly.

### DETAILED DESCRIPTION OF THE PREFERRED EMBODIMENT

Now referring to the figures in general, set forth is a conventional golf cart 100 having a body 102 with an occupant seating area 104 positioned directly behind the steering wheel 106. The seating area consists of a seat cushion 108 and a back rear cushion 110. A roof structure 112 is supported by a right front stanchion 113 and a left front stanchion 114. Right rear stanchion 116 and left rear stanchion 118 provide rear support of the roof structure 112. The fan assembly 10 of the instant invention consists of a housing 11 having a height defined by a top 12 and bottom 14, and a width defined by a first edge 16 and a second edge 18. The housing 11 is substantially rectangular in shape having an upper right extension tab 19 and lower right extension tab 20 located along the first edge 16, and an upper left extension tab 22 and lower left extension tab 24 located along the second edge 18. The extension tabs are constructed and arranged to be placed over right rear stanchion 116 and left rear stanchion 118 allowing for ease of securement by use of a flexible strap at each extension tab. One end of strap 26 is attached to extension tab 19 by use of fastener 34; similarly one end of strap 28 is attached to extension tab 20. One end of strap 30 is attached to extension tab 22 by use of fastener 33; similarly one end of strap 32 is attached to extension tab 24. Each strap preferably made of flexible material having a hook and loop (Velcro) fastener. By way of example, strap 26 has a proximal end 35 attached to the extension tab 19 and is wrapped around right rear stanchion 116 with distal end 36 secured along the length of the strap 26 wherein an outer surface 38 of the strap 26 is of a loop material and an inner surface 40 of the distal end 36 is of a hook material which allows ease of installation and removal.

The housing 11 is of a width so as to bridge the rear stanchions 116,118 and in one embodiment can include a hinge 42 along the center of the housing 11 which allows for altering of the width. Alternatively the housing 11 can be made adjustable in width wherein a first side portion 44 can slide over a second side portion 46 thereby adjusting the distance between the first edge 16 and second edge 18 as needed for attachment to various spacing between stanchions from different golf cart manufacturers. The housing 11 employs rechargeable batteries 50 that are preferably introduced through the rear of the fan housing 11. The batteries 50 are sized to work in conjunction with the right fan 52 and left fan 54 to provide continuous operation of the fans for a period of time that will match a typical round of golf that is about four hours. The positioning of the housing 11 is directly behind the occupant seating area 104 and in close proximity to the back of the occupants, which allows for the use of high efficiency, low flow production fans 52,54. The fans 52,54 need not move extremely high volumes of air due to the close proximity of the fans to the back of the seating area 104. This close proximity allows for the use of higher efficiency magnetic drive fans thereby reducing the amount of battery power required or otherwise allowing the use of smaller batteries 50 within the housing 11. The fan assembly 10 may also be connected directly to the golf cart batteries, not shown, for use in a more permanent situation, the higher efficiency fans 52,54 will not drain the golf cart batteries significantly and the fans 52,54 could be turned on and off by the use of pressure sensitive switches or proximity sensors.

In the primary embodiment, the batteries 50 can be recharged by an A/C adapter 60 having a male plug 62 for receipt by a female plug 64. The adapter 60 is secured to a conventional A/C power supply adapter, not shown, for conversion to D.C. current and voltage monitoring at the female plug 64. The female plug 64 is connected to a battery charger, not shown, for recharging the batteries 50 between uses, or as an alternate power source during operation. Each fan 52,54 can be operated independently by a power switch 66 for operation of fan 52, and a separate power switch 68 for operation of fan 54. Each switch preferably has an off, low, and high position. Alternatively, the operation can be controlled by use of a pressure sensitive, or proximity sensor, switch 70 located on the seat cushion 108, or a pressure sensitive, or proximity sensor, switch 72 located on back rear cushion 110. The use of a pressure sensitive, or a proximity sensor, switch allows operation of the fan only when an individual is either seated in the golf cart 100 on the seat cushion 108 or leaning against the back rear cushion 110. For example, when an individual is moving, the individual may wish to disable the fan and can lean forward if the pressure sensitive, or proximity sensor, switch 72 is mounted on the back rear cushion 110. This is of benefit when the golfer is moving at a high rate of speed wherein the fan is not necessary thereby extending the life of the batteries 50. If the pressure sensitive, or proximity sensor, switch 70 is placed on the seat cushion 108, then the fan is operated every time the individual sits within the golf cart 100, and the fan will turn off whenever the individual leaves the golf cart 100 to play. Without a pressure sensitive switch, or a proximity sensor switch, the individual would need to activate either power switch 66 or 68, or both, as necessary to provide proper cooling.

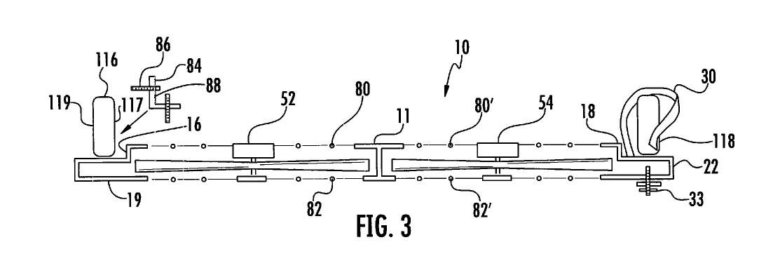

Referring to FIG. 3, shown is a top cross sectional view of the fan assembly 10, showing the housing 11 with fans 52 and 54 placed within a screened vent 80 and 82, with extension tab 19 along the first edge 16 and extension tab 22 located along the second edge 18. The extension tabs may alternatively be in the form of a right angle bracket 84, wherein an outer edge 86 of the bracket 84 may be placed on the inner edge on 117 of the right rear stanchion 116, or alternatively, the inner edge 88 of the bracket 84 can be placed on an outer edge 119 of the right rear stanchion 116. The brackets 84 can be formed integral with the housing 11 for ease of mounting, or used in combination with the extension tabs 19,20,22,24. The portability of the fan assembly 10 allows for adaptability to the various types of golf carts 100 when the individual chooses to transfer the fan assembly 10 from cart to cart, where an individual changes carts due to courses, or even if the golf course has different style carts within their fleet. Further, including a handle, not shown, on the top 12 of the housing 11, either formed integrally to the housing 11 or alternately a strap along the top 12 of the housing 11, allows an individual to easily transport the fan assembly 10 from one golf cart 100 to another. The angle bracket 84 further allows for this flexibility as well as provides a means for permanently mounting the housing 11 should the consumer desire. The angle bracket 84 is most preferable for instances of permanent installation or concealment of the fasteners can be readily performed by side access versus frontal, or rear, access.

In the preferred embodiment, the housing 11 has the bottom 14, which sits along an upper edge 120 of the back rear cushion 110 of the seating area 104. This allows the use of the flexible Velcro attachment straps as the housing 11 can rest on the top of the back rear cushion 110 of the seating area 104 so that no vertical movement occurs while the golf cart 100 is being moved from one location to another. It is well known that golf carts traverse in a relatively rough environment with the occupants driving on grass or transitioning from grass to gravel, causing items in the golf cart 100 to shift. The shocks on the golf cart 100 provide only basic cushioning of the ride thus the placement of the housing 11 on top of the back rear cushion 110 provides the necessary support despite the roughest operating conditions. The position of the housing 11 not only provides cooling directly behind the occupant's upper back, neck, and head area, but further takes advantage of the supportability of the seating area 104. In addition, the close positioning of the fan assembly 10 to the seating area 104 allows the use of very low power consuming type fans that need not rotate excessively to produce the desired result.

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A golf cart fan assembly comprising:
a housing having a top wall and a bottom wall, a front surface and a rear surface, and a width defined by a first edge and a second edge, said first edge securable to a first roof support stanchion on a golf cart and said second edge securable to a second roof support stanchion on the golf cart with said bottom wall juxtapositioned to a golf cart seat cushion positioned between said first and said roof support stanchions;
at least two fans mounted in a horizontal plane within said housing, each said fan constructed and arranged to direct an air flow;
a rechargeable battery located within said housing; and, a switch means for electrically coupling said battery to said fans.

2. The golf cart fan assembly according to claim 1 including a battery charger formed integral to said housing, said battery charger having an input for coupling to a conventional AC outlet and output converted into direct current.

3. The golf cart fan assembly according to claim 1 wherein said housing is attached to a golf cart by use of a flexible strap having a proximal end secured to each said edge of said housing and a distal end constructed and arranged to wrap around said stanchion before securement to said flexible strap, said flexible strap forming a hook and loop attachment.

4. The golf cart fan assembly according to claim 1 wherein said edges include a mounting tab extending outwardly therefrom for use in engaging said stanchions.

5. The golf cart fan assembly according to claim 1 wherein said rechargeable battery is a plurality of “D” sized batteries.

6. The golf cart fan assembly according to claim 1 wherein said battery is recharged external from said housing.

7. The golf cart fan assembly according to claim 1 wherein said switch means is a pressure sensitive operational switch positionable on a seat cushion to turn on the fans when the switch is occupied and turn off the fans when the seat is not occupied.

8. The golf cart fan assembly according to claim 1 wherein said switch means is a proximity sensor operational switch positionable on a seat cushion to turn on the fans when the cart is occupied and turn off the fans when the cart is not occupied.

9. The golf cart fan assembly according to claim 1 including a proximity sensor operational switch positionable on said back rear cushion to turn off the fans when the cart is not occupied.

10. The golf cart fan assembly according to claim 1 wherein the width of said housing is adjustable.

11. A golf cart fan assembly comprising:
a housing having a top wall and a bottom wall, a front surface and a rear surface, and a width defined by a first edge and a second edge, said first edge securable to a first roof support stanchion on a golf cart and said second edge securable to a second roof support stanchion on the golf cart with said bottom wall juxtapositioned to a golf cart seat cushion positioned between said first and said roof support stanchions;
a pair of direct current powered fans mounted in a horizontal plane within said housing, each said fan constructed and arranged to direct an air flow toward an occupied seating area;
a rechargeable battery located within said housing;
a switch means for electrically coupling said battery to said fans; and
flexible straps each having a proximal end secured to each said edge of said housing and a distal end constructed and arranged to wrap around a stanchion and attachment to said strap, said strap forming a hook and loop attachment

12. The golf cart fan assembly according to claim 11 wherein said switch means is a pressure sensitive operational switch positionable on a seat cushion to turn on the fans when the switch is occupied and turn off the fans when the seat is not occupied.

13. The golf cart fan assembly according to claim 11 wherein said switch means is a proximity sensor operational switch positionable on a seat cushion to turn on the fans when the cart is occupied and turn off the fans when the cart is not occupied.

14. The golf cart fan assembly according to claim 11 wherein the width of said housing is adjustable.
